(19) United States
(12) Patent Application Publication
(10) Pub. No.: US 2026/0155509 A1
(43) Pub. Date: Jun. 4, 2026

(54) SECONDARY BATTERY

(71) Applicant: SAMSUNG SDI CO., LTD., Yongin-si (KR)

(72) Inventor: Taewoong JANG, Yongin-si (KR)

(21) Appl. No.: 19/221,799

(22) Filed: May 29, 2025

(30) Foreign Application Priority Data
Dec. 3, 2024 (KR) 10-2024-0177352

(51) Int. Cl. H01M 50/197; H01M 50/186; H01M 50/191; H01M 50/193; H01M 50/586; H01M 50/595

(52) U.S. Cl. CPC H01M 50/197; H01M 50/186; H01M 50/191; H01M 50/193; H01M 50/586; H01M 50/595

(57) ABSTRACT

A secondary battery includes an electrode assembly including a first electrode having a first electrode tab coupled to an insulating tape, a separator, and a second electrode, a case accommodating the electrode assembly on one open side, the case being electrically connected to the second electrode, a cap assembly sealing the one open side of the case, the cap assembly being electrically connected to the first electrode tab, an insulating sheet between the cap assembly and the electrode assembly; and a sealing tape surrounding the electrode assembly and the insulating tape.

### CROSS-REFERENCE TO RELATED APPLICATION

The present application claims priority to and the benefit of Korean Patent Application No. 10-2024-0177352, filed on Dec. 3, 2024, in the Korean Intellectual Property Office, the entire disclosure of which is incorporated by reference herein.

### BACKGROUND

### 1. Field

The present disclosure relates to a secondary battery.

### 2. Description of Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above information disclosed in this Background section is for enhancement of understanding of the background of the present disclosure, and therefore, it may contain information that does not constitute related (or prior) art.

### SUMMARY

Embodiments include a secondary battery, including an electrode assembly including a first electrode having a first electrode tab coupled to an insulating tape, a separator, and a second electrode, a case accommodating the electrode assembly on one open side, the case being electrically connected to the second electrode, a cap assembly sealing the one open side of the case, the cap assembly being electrically connected to the first electrode tab, an insulating sheet between the cap assembly and the electrode assembly, and a sealing tape surrounding the electrode assembly and the insulating tape.

The sealing tape may include a base part surrounding a periphery of the electrode assembly, and a bending part bent at an end portion of the base part, the bending part being on the insulating sheet.

The sealing tape may include a metal layer including a metal material, an insulating layer including an insulating material, the insulating layer being on the metal layer, and a first adhesive layer on the insulating layer.

The sealing tape may further include a second adhesive layer between the metal layer and the insulating layer, the second adhesive layer bonding the metal layer with the insulating layer.

Each of the base part and the bending part includes the first metal layer, the second adhesive layer, the insulating layer, and the first adhesive layer.

The base part may be attached to the periphery of the electrode assembly by the first adhesive layer, and the bending part may be attached to the insulating sheet by the first adhesive layer.

The base part may include the metal layer, the second adhesive layer, the insulating layer, and the first adhesive layer, and the bending part may include the metal layer, the second adhesive layer, and the insulating layer.

The base part may be attached to the periphery of the electrode assembly by the first adhesive layer, and the bending part may be on the insulating sheet, resulting in the insulating layer facing the insulating sheet.

The base part may include the metal layer, the second adhesive layer, the insulating layer, and the first adhesive layer, and the bending part may include the metal layer and the second adhesive layer.

The base part may be attached to the periphery of the electrode assembly by the first adhesive layer, and the bending part may be attached to the insulating sheet by the second adhesive layer.

The metal layer may be a coating of a metal material on the insulating layer.

Each of the base part and the bending part may include the metal layer, the insulating layer, and the first adhesive layer.

The base part may be attached to the periphery of the electrode assembly by the first adhesive layer, and the bending part may be attached to the insulating sheet by the first adhesive layer.

The base part may include the metal layer, the insulating layer, and the first adhesive layer, and the bending part may include the metal layer and the insulating layer.

The base part may be attached to the periphery of the electrode assembly by the first adhesive layer, and the bending part may be on the insulating sheet, resulting in the insulating layer facing the insulating sheet.

The bending part may include a plurality of notches spaced apart by a predetermined gap along a circumferential direction, the plurality of notches being cut along a direction perpendicular to the circumferential direction.

A length of the bending part may be a same as or smaller than a first length from an inner circumferential surface of the case to an end portion of the insulating tape coupled to the first electrode tab, and may be a same as or greater than a second length from the inner circumferential surface of the case to an end portion of the separator bent in a direction parallel to the bending part.

A length of the bending part may be a same as or smaller than a first length from an inner circumferential surface of the case to an end portion of the insulating tape coupled to the first electrode tab, and may be a same as or greater than a third length from the inner circumferential surface of the case to an end portion of the insulating sheet.

The metal layer may include at least one of copper and a copper alloy.

The insulating layer may include at least one of oriented polystyrene, thermoplastic vulcanizate, polyethylene terephthalate, polypropylene and polyamide.

These and other aspects and features of the present disclosure will be described in or will be apparent from the following description of embodiments of the present disclosure.

According to some embodiments of the present disclosure, a sealing tape that surrounds an electrode assembly accommodated in a case of a secondary battery and an insulating tape coupled to a first electrode tab prevents damage to the insulating tape when the case is bonded with the cap assembly by welding.

According to some embodiments of the present disclosure, the outer surface of the sealing tape of the secondary battery is formed of a metal layer to prevent the welding heat generated by welding from being transferred to the electrode assembly and insulating tape.

According to some embodiments of the present disclosure, the metal layer formed on the outer surface of the sealing tape of the secondary battery contacts the inner circumferential surface of the case to transmit the welding heat generated by welding to the case, thereby dissipating the welding heat.

However, aspects and features of the present disclosure are not limited to those described above, and other aspects and features not mentioned will be clearly understood by a person skilled in the art from the detailed description, described below.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

Features will become apparent to those of ordinary skill in the art by describing in detail exemplary embodiments with reference to the attached drawings, in which:

FIG. 1 is a cross-sectional view illustrating an example of a secondary battery according to some embodiments of the present disclosure;

FIG. 2 is a separated perspective view illustrating an example of a secondary battery according to some embodiments of the present disclosure;

FIG. 3 is a cross-sectional view illustrating a first embodiment of a sealing tape in a secondary battery according to some embodiments of the present disclosure;

FIG. 4 is a cross-sectional view illustrating a second embodiment of a sealing tape of a secondary battery according to some embodiments of the present disclosure;

FIG. 5 is a cross-sectional view illustrating a third embodiment of a sealing tape of a secondary battery according to some embodiments of the present disclosure;

FIG. 6 is a cross-sectional view illustrating a fourth embodiment of a sealing tape of a secondary battery according to some embodiments of the present disclosure;

FIG. 7 is a cross-sectional view illustrating a fifth embodiment of a sealing tape of a secondary battery according to some embodiments of the present disclosure;

FIG. 8 is a plan view illustrating a first embodiment of a notch formed on a sealing tape of a secondary battery according to some embodiments of the present disclosure;

FIG. 9 is a plan view illustrating a second embodiment of a notch formed on a sealing tape of a secondary battery according to some embodiments;

FIG. 10 is a perspective view illustrating an example in which a sealing tape is placed when a cap assembly of a secondary battery remains open;

FIG. 11 is a perspective view illustrating an example in which a bending part of a sealing tape is bent when a cap assembly of a secondary battery remains open;

FIG. 12 is a plan view illustrating an example where a bending part of a sealing tape of a secondary battery is bent according to some embodiments of the present disclosure;

FIG. 13 is a partial cross-sectional view illustrating an example where a bending part of a sealing tape is bent in a secondary battery according to some embodiments of the present disclosure; and

FIG. 14 is a cross-sectional view illustrating an example where a lower insulator is coupled to a cap assembly of a secondary battery according to some embodiments of the present disclosure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those of ordinary skill in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (or under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

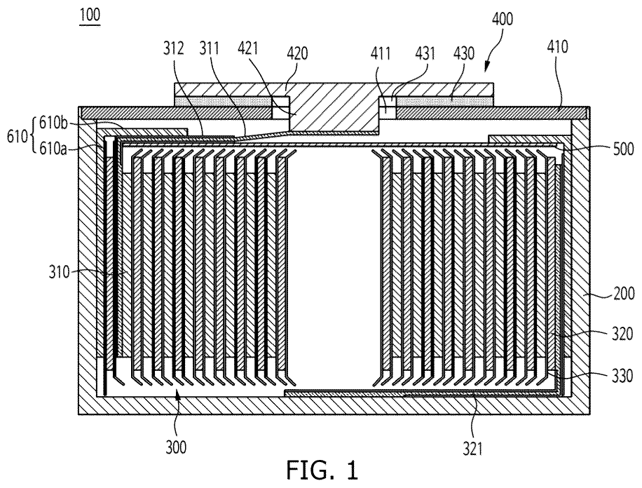

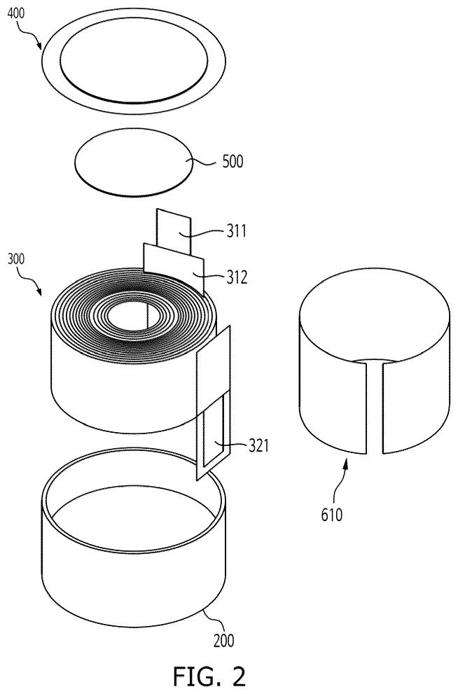

FIG. 1 is a cross-sectional view illustrating an example of a secondary battery according to some embodiments of the present disclosure, and FIG. 2 is a separated perspective view illustrating an example of a secondary battery according to some embodiments of the present disclosure.

Referring to FIG. 1 and FIG. 2, a secondary battery 100 according to some embodiments of the present disclosure may include an electrode assembly 300 including a first electrode 310 including a first electrode tab 311 coupled with an insulating tape 312, a separator 330, and a second electrode 320, and a case 200 that accommodates the electrode assembly 300 on one open side and is electrically connected to the second electrode 320, a cap assembly 400 that closes the one open side of the case 200 and is electrically connected to the first electrode tab 311, an insulating sheet 500 placed between the cap assembly 400 and the electrode assembly 300, and a sealing tape 610 that surrounds the electrode assembly 300 and the insulating tape 312.

The electrode assembly 300 may include the separator 330 and the first electrode 310 and the second electrode 320 positioned with the separator 330 interposed therebetween and may be wound in a jelly-roll shape.

The first electrode 310 includes a first substrate and a first active material layer on the first substrate. A first electrode tab 311 may extend outwardly from a first uncoated portion of the first substrate at where the first active material layer is not located, and the first electrode tab 311 may be electrically connected to the cap assembly 400.

The second electrode 320 includes a second substrate and a second active material layer on the second substrate. A second electrode tab 321 may extend outwardly from a second uncoated portion of the second substrate at where the second active material layer is not located, and the second electrode tab 321 may be electrically connected to the case 200. The first electrode tab 311 and the second electrode tab 321 may extend in opposite directions.

The first electrode 310 may act as a positive electrode. In such an embodiment, the first substrate may be made of, for example, an aluminum foil, and the first active material layer may include, for example, a transition metal oxide. The second electrode 320 may act as a negative electrode. In such an embodiment, the second substrate may be made of, for example, a copper foil or a nickel foil, and the second active material layer may include graphite, for example.

The separator 330 prevents a short circuit between the first electrode 310 and the second electrode 320 while allowing movement of lithium ions therebetween. The separator 330 may be made of, for example, a polyethylene film, a polypropylene film, a polyethylene-polypropylene film, or the like.

The case 200 accommodates the electrode assembly 300 and, together with the cap assembly 400, forms the external appearance of the secondary battery. The case 200 may have a substantially cylindrical body portion and a bottom portion connected to one side (e.g., to one end) of the body portion. The case 200 may be made of a metal, such as aluminum, aluminum alloy, or nickel-plated steel.

The second electrode tab 321 may be coupled and electrically connected to a bottom of the case 200. An end portion of the first electrode tab 311 may be coupled to a protrusion 421 of a terminal plate 420. The insulating tape 312 may be bonded to the first electrode tab 311, except for the portion coupled to the protrusion 421 of the terminal plate 420. The first electrode tab 311 bent upward (in the configuration shown) from the electrode assembly 300 may contact a cap plate 410 of the cap assembly 400 or the inner circumferential surface of the case 200, which leads to short-circuits, so that the insulating tape 312 may be attached to the first electrode tab 310.

The cap assembly 400 may include the cap plate 410 including a through hole 411, the terminal plate 420 placed on the cap plate 410 and including the protrusion 421 inserted into the through hole 411, and an upper insulator 430 disposed between the cap plate 410 and the terminal plate 420.

The cap plate 410 may be formed in a disk shape with the through hole 411 at the center. The cap plate 410 may have a greater diameter than the terminal plate 420 and the upper insulator 430. The cap plate 410 may be bonded to the upper side end of the case 200 by welding to close the one open side of the case 200. The cap plate 410 may have various shapes depending on the shape of the case to which the cap plate 410 is coupled.

The terminal plate 420 may be formed in a circular plate shape with a smaller diameter than the cap plate 410 and may include the protrusion 421 at the center to be inserted into the through hole 411 of the cap plate 410. The protrusion 421 of the terminal plate 420 may protrude toward the electrode assembly 300 while being inserted into the through hole 411. The first electrode tab 311 may be coupled to the protrusion 421 of the terminal plate 420. The shape of the terminal plate 420 may vary depending on the shape of the cap plate 410.

The first electrode tab 311 may be coupled to the protrusion 421 of the terminal plate 420, and the second electrode tab 321 may be coupled to the case 200. The terminal plate 420 may function as a positive electrode and the case 200 may function as a negative electrode.

The upper insulator 430 may be arranged between the cap plate 410 and the terminal plate 420 so that the cap plate 410 and the terminal plate 420 may be electrically insulated. The cap plate 410 and the terminal plate 420 may be made of a conductive metal material and respectively electrically connected to a negative electrode, which is the second electrode tab 321, and a positive electrode, which is the first electrode tab 311, so that the upper insulator 430 may insulate the cap plate 410 and the terminal plate 420 to prevent short-circuits. The upper insulator 430 may be made of a resin such as polypropylene or polyethylene.

The upper insulator 430 may be formed in a disk shape with an insertion hole 431 at the center in a similar manner as the cap plate 410. The protrusion 421 of the terminal plate 420 may penetrate the insertion hole 431 of the upper insulator 430 and the through hole 411 of the cap plate 410 to be placed inside the case 200. The first electrode tab 311 may be coupled to the protrusion 421 of the terminal plate 420 placed inside the case 200. The outer diameter of the upper insulator 430 may be the same as or similar to the outer diameter of the terminal plate 420. The outer diameter of the cap plate 410 may be greater than the outer diameter of the upper insulator 430 and the outer diameter of the terminal plate 420. The diameter of the insertion hole 431 of the upper insulator 430 may be the same as or similar to the diameter of the through hole 411 of the cap plate 410.

The upper insulator 430 may be placed between the cap plate 410 and the terminal plate 420 and coupled to the cap plate 410 and the terminal plate 420 by heating and pressurizing the cap plate 410 and the terminal plate 420 using a heat-fusion method.

The insulating sheet 500 may be arranged between the cap assembly 400 and the electrode assembly 300 to insulate between the upper portion of the electrode assembly 300 and the first electrode tab 311. The insulating sheet 500 may be arranged on the upper portion of the electrode assembly 300. The diameter of the insulating sheet 500 may be formed smaller than the outer diameter of the electrode assembly 300. The insulating sheet 500 may be made of a resin such as polypropylene or polyethylene.

The sealing tape 610 may surround the electrode assembly 300 and the insulating tape 312. The sealing tape 610 may be formed of a rectangular shape and attached along the periphery of the electrode assembly 300. The portion protruding upward to the upper part of the electrode assembly 300 may be bent and placed on the insulating sheet 500. The portion of the sealing tape 610 that is bent onto the insulating sheet 500 may be arranged to surround the insulating tape 312.

The sealing tape 610 may include a base part 610a that surrounds the periphery of the electrode assembly 300, and a bending part 610b that is bent at an end of the base part 610a and placed on the insulating sheet 500. The base part 610a of the sealing tape 610 may first be coupled to the electrode assembly 300 while surrounding the periphery of the electrode assembly 300, and then the bending part 610b, which protrudes above the upper part of the electrode assembly 300, may be bent and placed on the insulating sheet 500. The bending part 610b may be placed along the periphery of the insulating sheet 500. The bending part 610b may be placed on the insulating tape 312 bonded to the first electrode tab 311 with the insulating sheet 500.

Referring to FIG. 1 and FIG. 2, the secondary battery 10 may be a coin type or a button type. However, it may be other types of secondary batteries (e.g., a cylindrical battery). Referring to FIG. 1, a first electrode tab may protrude upward to be connected to a cap assembly, and a second electrode tab may protrude downward to be connected to a case, but the first electrode tab and the second electrode tab both may protrude upward to be connected to the cap assembly and the case, respectively.

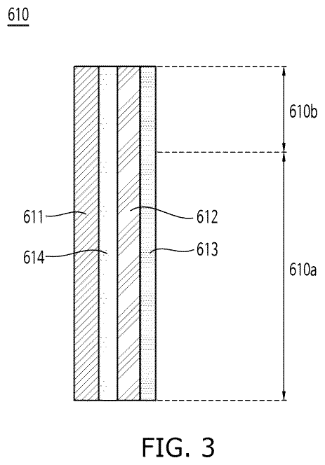

FIG. 3 is a cross-sectional view illustrating a first embodiment of a sealing tape in a secondary battery according to some embodiments of the present disclosure.

Referring to FIG. 1 and FIG. 3, a sealing tape 610 according to a first embodiment may include a metal layer 611 formed of a metal material, an insulating layer 612 formed of an insulating material and disposed on the metal layer 611, a first adhesive layer 613 placed on the insulating layer 612, and a second adhesive layer 614 disposed between the metal layer 611 and the insulating layer 612 to ensure adhesion between the metal layer 611 and the insulating layer 612.

The metal layer 611 may be formed of a metal foil including at least one of copper and a copper alloy. The insulating layer 612 may be formed of an insulating film including at least one of oriented polystyrene, thermoplastic vulcanizate, polyethylene terephthalate, polypropylene, and polyimide. The first adhesive layer 613 may be formed of an adhesive applied to the insulating layer 612, or an adhesive film attached to the insulating layer 612. The second adhesive layer 614 may be formed of an adhesive applied to at least one of the metal layer 611 and the insulating layer 612, or an adhesive film attached to at least one of the metal layer 611 and the insulating layer 612.

The metal layer 611, the second adhesive layer 614, the insulating layer 612, and the first adhesive layer 613 of the sealing tape 610 according to the first embodiment may have the same length. According to some embodiments, the base part 610a and the bending part 610b of the sealing tape 610 may be formed in a laminate structure including the metal layer 611, the second adhesive layer 614, the insulating layer 612, and the first adhesive layer 613.

The base part 610a of the sealing tape 610 may be attached to the periphery of the electrode assembly 300 by the first adhesive layer 613. The bending part 610b of the sealing tape 610 may be bent to the upper part of the insulating sheet 500, and then attached to the insulating sheet 500 by the first adhesive layer 613. A portion of the bending part 610b may be attached to the insulating tape 312 coupled to the first electrode tab 311.

When the sealing tape 610 is disposed to surround the electrode assembly 300 and the insulating tape 312, the metal layer 611 of the base part 610a may contact the inner circumferential surface of the case 200, and the bending part 610b may be placed to face the cap plate 410. When the case 200 is bonded to the cap plate 410 by welding, the metal layer 611 placed on the outer surface of the sealing tape 610 may protect the electrode assembly 300 and the insulating tape 312. The welding heat generated by welding the case 200 and the cap plate 410 may be prevented from being transferred to the electrode assembly 300 and the insulating tape 312. The metal layer 611 may be in contact with the inner circumferential surface of the case 200 to allow the welding heat to be transferred to the case 200 and dissipated to the outside.

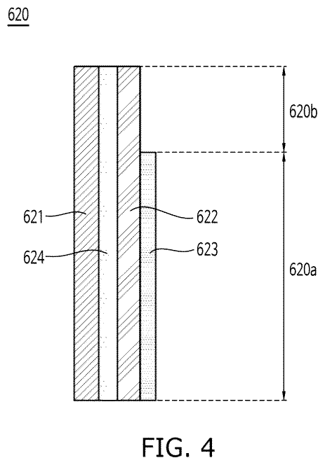

FIG. 4 is a cross-sectional view illustrating a second embodiment of a sealing tape of a secondary battery According to some embodiments of the present disclosure.

Referring to FIG. 1 and FIG. 4, a sealing tape 620 according to a second embodiment may include a metal layer 621 formed of a metal material, an insulating layer 622 formed of an insulating material and disposed on the metal layer 621, a first adhesive layer 623 placed on the insulating layer 622, and a second adhesive layer 624 disposed between the metal layer 621 and the insulating layer 622 to ensure adhesion between the metal layer 621 to the insulating layer 622.

The metal layer 621 may be formed of a metal foil including at least one of copper and a copper alloy. The insulating layer 622 may be formed of an insulating film including at least one of oriented polystyrene, thermoplastic vulcanizate, polyethylene terephthalate, polypropylene, and polyimide. The first adhesive layer 623 may be formed of an adhesive applied to the insulating layer 622, or an adhesive film attached to the insulating layer 622. The second adhesive layer 624 may be formed of an adhesive applied to at least one of the metal layer 621 and the insulating layer 622, or an adhesive film attached to at least one of the metal layer 621 and the insulating layer 622.

The metal layer 621, the second adhesive layer 624, and the insulating layer 622 of the sealing tape 620 according to the second embodiment may have the same length, and the first adhesive layer 623 may have a relatively smaller length. According to some embodiments, a base part 620a of the sealing tape 620 may have formed in a laminate structure including the metal layer 621, the second adhesive layer 624, the insulating layer 622, and the first adhesive layer 623. A bending part 620b may be formed in a laminate structure including the metal layer 621, the second adhesive layer 624, and the insulating layer 622.

The base part 620a of the sealing tape 620 may be attached to the periphery of the electrode assembly 300 by the first adhesive layer 623. The bending part 620b of the sealing tape 620 may be bent toward the upper part of the insulating sheet 500 and placed on the insulating sheet 500, so that the insulating layer 622 may face the insulating sheet 500. A portion of the bending part 620b may be placed on the insulating tape 312 coupled to the first electrode tab 311.

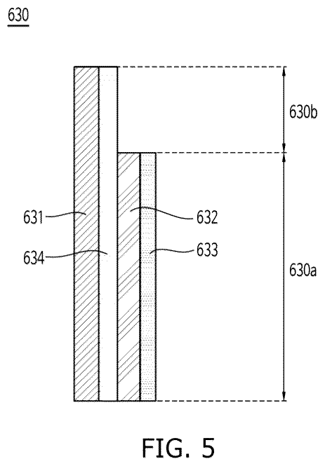

FIG. 5 is a cross-sectional view illustrating a third embodiment of a sealing tape of a secondary battery according to some embodiments of the present disclosure.

Referring to FIG. 1 and FIG. 5, a sealing tape 630 according to a third embodiment may include a metal layer 631 formed of a metal material, an insulating layer 632 formed of an insulating material and disposed on the metal layer 631, a first adhesive layer 633 disposed on the insulating layer 632, and a second adhesive layer 634 disposed between the metal layer 631 and the insulating layer 632 to ensure adhesion between the metal layer 631 to the insulating layer 632.

The metal layer 631 may be formed of a metal foil including at least one of copper and a copper alloy. The insulating layer 632 may be formed of an insulating film including at least one of oriented polystyrene, thermoplastic vulcanizate, polyethylene terephthalate, polypropylene, and polyimide. The first adhesive layer 633 may be formed of an adhesive applied to the insulating layer 632, or an adhesive film attached to the insulating layer 632. The second adhesive layer 634 may be formed of an adhesive applied to at least one of the metal layer 631 and the insulating layer 632, or an adhesive film attached to at least one of the metal layer 631 and the insulating layer 632.

The metal layer 631 and the second adhesive layer 634 of the sealing tape 630 according to the third embodiment may have the same length, and the insulating layer 632 and the first adhesive layer 633 may have a relatively smaller length. The insulating layer 632 and the first adhesive layer 633 may have the same or similar length. According to some embodiments, a base part 630a of the sealing tape 630 may be formed in a laminate structure including the metal layer 631, the second adhesive layer 634, the insulating layer 632, and the first adhesive layer 633. A bending part 630b may be formed in a laminate structure including the metal layer 631 and the second adhesive layer 634.

The base part 630a of the sealing tape 630 may be attached to the periphery of the electrode assembly 300 by the first adhesive layer 633. The bending part 630b of the sealing tape 630 may be bent toward the upper part of the insulating sheet 500 and then attached to the insulating sheet 500 by the second adhesive layer 634. A portion of the bending part 630b may be attached to the insulating tape 312 coupled to the first electrode tab 311.

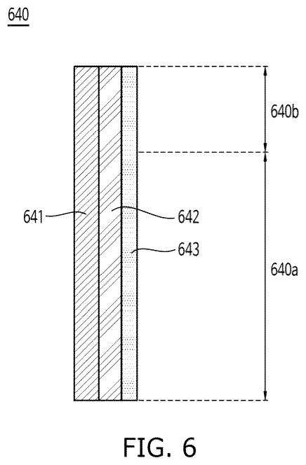

FIG. 6 is a cross-sectional view illustrating a fourth embodiment of a sealing tape of a secondary battery according to some embodiments of the present disclosure.

Referring to FIG. 1 and FIG. 6, a sealing tape 640 according to a fourth embodiment may include a metal layer 641 formed of a metal material, an insulating layer 642 formed of an insulating material and placed on the metal layer 641, and a first adhesive layer 643 disposed on the insulating layer 642.

The metal layer 641 may be formed integrally with the insulating layer 642 by coating a metal material including at least one of copper and a copper alloy on the insulating layer 642. According to some embodiments, the metal layer 641 may be coated by applying and rolling the metal material on the insulating layer 642. In some embodiments, the metal layer 641 may be formed by depositing the metal material on the insulating layer 642 using a Physical Vapor Deposition (PVD) or Chemical Vapor Deposition (CVD) method.

The insulating layer 642 may be formed of an insulating film including at least one of oriented polystyrene, thermoplastic vulcanizate, polyethylene terephthalate, polypropylene, and polyimide. The first adhesive layer 643 may be formed of an adhesive applied to the insulating layer 642, or an adhesive film attached to the insulating layer 642.

The metal layer 641, the insulating layer 642, and the first adhesive layer 643 of the sealing tape 640 according to the fourth embodiment may have the same length. According to some embodiments, a base part 640a and a bending part 640b of the sealing tape 640 may be formed in a laminate structure including the metal layer 641, the insulating layer 642, and the first adhesive layer 643.

The base part 640a of the sealing tape 640 may be attached to the periphery of the electrode assembly 300 by the first adhesive layer 643. The bending part 640b of the sealing tape 640 may be bent toward the upper part of the insulating sheet 500, and then attached to the insulating sheet 500 by the first adhesive layer 643. A portion of the bending part 640b may be attached to the insulating tape 312 coupled to the first electrode tab 311.

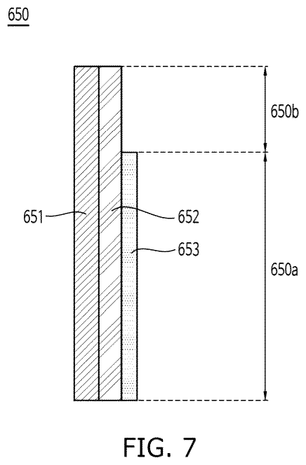

FIG. 7 is a cross-sectional view illustrating a fifth embodiment of a sealing tape of a secondary battery according to some embodiments of the present disclosure.

Referring to FIG. 1 and FIG. 7, a sealing tape 650 of the fifth embodiment may include a metal layer 651 formed of a metal material, an insulating layer 652 formed of an insulating material and placed on the metal layer 651, and a first adhesive layer 653 placed on the insulating layer 652.

The metal layer 651 may be formed integrally with the insulating layer 652 by coating the insulating layer 652 with a metal material including at least one of copper and a copper alloy. According to some embodiments, the metal layer 651 may be coated by applying and rolling the metal material on the insulating layer 652. In some embodiments, the metal layer 651 may be formed by depositing the metal material on the insulating layer 652 using a Physical Vapor Deposition (PVD) or Chemical Vapor Deposition (CVD) method.

The insulating layer 652 may be formed of an insulating film including at least one of oriented polystyrene, thermoplastic vulcanizate, polyethylene terephthalate, polypropylene, and polyimide. The first adhesive layer 653 may be formed of an adhesive applied to the insulating layer 652 or an adhesive film attached to the insulating layer 652.

The metal layer 651 and the insulating layer 652 of the sealing tape 650 according to the fifth embodiment may have the same length, and the first adhesive layer 653 may have a relatively smaller length. According to some embodiments, a base part 650a of the sealing tape 650 may be formed in a laminate structure including the metal layer 651, the insulating layer 652, and the first adhesive layer 653. A bending part 650b may be formed in a laminate structure including the metal layer 651 and the insulating layer 652.

The base part 650a of the sealing tape 650 may be attached to the periphery of the electrode assembly 300 by the first adhesive layer 653. The bending part 650b of the sealing tape 650 may be bent toward the upper part of the insulating sheet 500 and placed on the insulating sheet 500 so that the insulating layer 652 may face the insulating sheet 500. A portion of the bending part 650b may be disposed on the insulating tape 312 coupled to the first electrode tab 311.

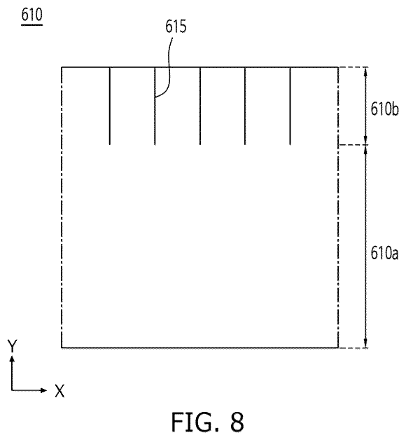

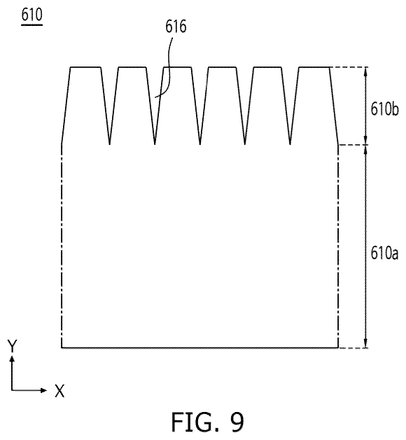

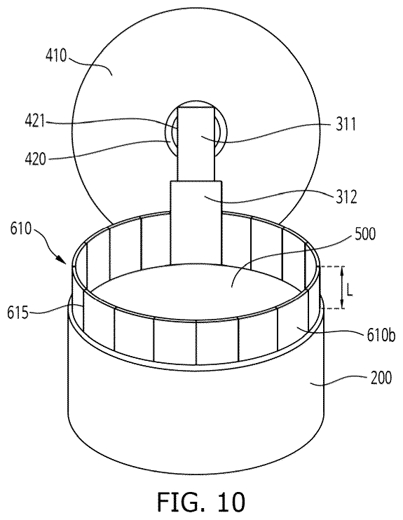

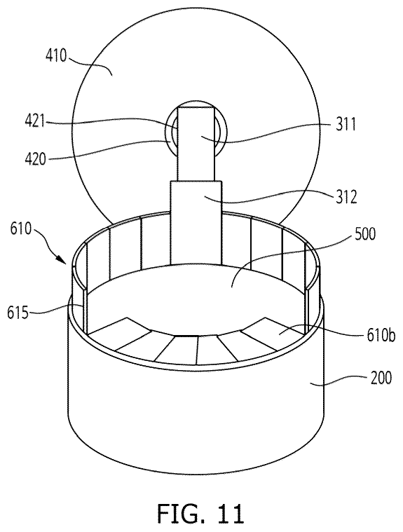

FIG. 8 is a plan view illustrating a first embodiment of a notch formed on a sealing tape of a secondary battery according to some embodiments of the present disclosure, FIG. 9 is a plan view illustrating a second embodiment of a notch formed on a sealing tape of a secondary battery according to some embodiments. FIG. 10 is a perspective view illustrating an example in which a sealing tape is placed when a cap assembly of a secondary battery remains open, and FIG. 11 is a perspective view illustrating an example in which a bending part of a sealing tape is bent when a cap assembly of a secondary battery remains open.

Referring to FIG. 8 to FIG. 11, the bending part 610b of the sealing tape 610 may be spaced apart by a predetermined gap along a circumferential direction X and may include a plurality of notches cut along a direction Y perpendicular to the circumferential direction X. A notch may be formed in another embodiment of the sealing tape with reference to FIG. 4 to FIG. 7.

Referring to FIG. 8, a notch 615 according to the first embodiment may be formed in a straight-line shape. Referring to FIG. 9, a notch 615 according to the second embodiment may be formed in a V shape. However, the shape of the notch may vary such as a U shape, a diagonal shape, etc.

A secondary battery may be assembled in a first stage by attaching the base part 610a of the sealing tape 610 along the periphery of the electrode assembly, accommodating the electrode assembly in the case 200, and placing the insulating sheet 500 on the electrode assembly as shown in FIG. 10. As shown in FIG. 11, a secondary battery may be assembled in a second stage by bending a plurality of bending parts 610b cut by the notch 615 on the insulating sheet 500 to be bonded onto the insulating sheet 500. A portion of the bending part 610b may be bonded onto the insulating tape 312. The cap plate 410 may be placed and then bonded to the case 200 by welding.

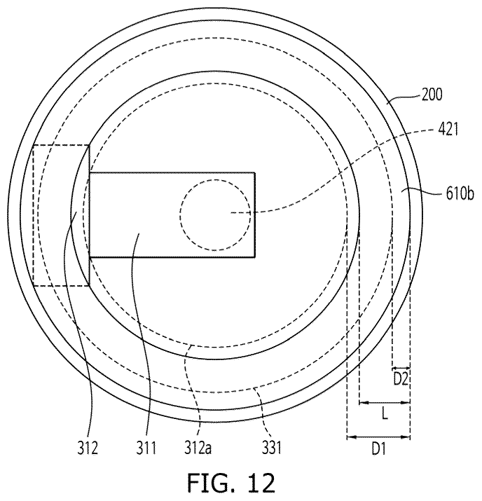

FIG. 12 is a plan view illustrating an example where a bending part of a sealing tape of a secondary battery is bent according to some embodiments of the present disclosure.

Referring to FIG. 12, a length L of the bending part 610b of the sealing tape may be the same as or smaller than a first length D1 from the inner circumferential surface of the case 200 to an end portion 312a of the insulating tape 312 coupled to the first electrode tab 311. When the length L of the bending part 610b is greater than the first length D1, the metal layer of the bending part 610b may contact the first electrode tab 311, which may cause short-circuits.

The length L of the bending part 610b of the sealing tape may be the same as or greater than a second length D2 from the inner circumferential surface of the case 200 to an end portion 331 of the separator 330 that is bent in a direction parallel to the bending part 610b. When the length L of the bending part 610b is smaller than the second length D2, it may become difficult to efficiently block the welding heat generated by welding the case 200 and the cap plate 410.

The length of the bending part may be formed as above in another embodiment of the sealing tape described with reference to FIG. 4 to FIG. 7.

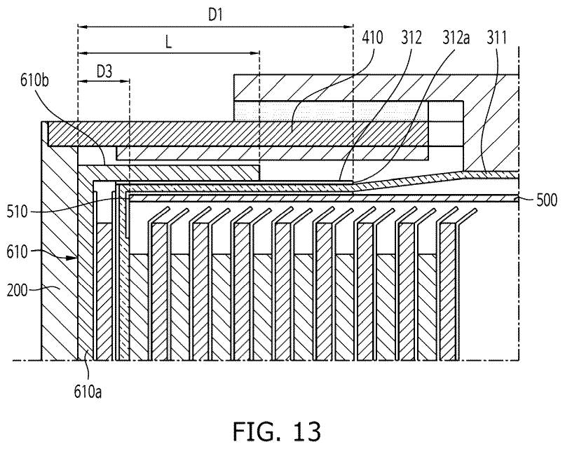

FIG. 13 is a partial cross-sectional view illustrating an example where a bending part of a sealing tape is bent in a secondary battery according to some embodiments of the present disclosure.

Referring to FIG. 13, the length L of the bending part 610b of the sealing tape 610 may be the same as or smaller than the first length D1 from the inner circumferential surface of the case 200 to the end portion 312a of the insulating tape 312 coupled to the first electrode tab 311.

The length L of the bending part 610b of the sealing tape 610 may be the same as or smaller than a third length D3 from the inner circumferential surface of the case 200 to an end portion 510 of the insulating sheet 500. When the length L of the bending part 610b is smaller than the third length D3, it may become difficult to efficiently block the welding heat generated by welding between the case 200 and the cap plate 410.

The length of the bending part may be formed as the above in another embodiment of the sealing tape described with reference to FIG. 4 to FIG. 7.

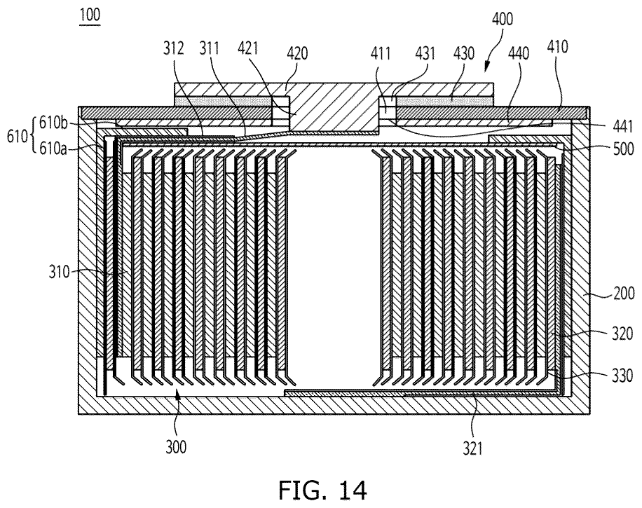

FIG. 14 is a cross-sectional view illustrating an example where a lower insulator is coupled to a cap assembly of a secondary battery according to some embodiments of the present disclosure.

Referring to FIG. 14, a secondary battery 100 according to some embodiments may further include a lower insulator 440 disposed between the cap plate 410 and the first electrode tab 311 to insulate between the cap plate 410 and the first electrode tab 311.

When the cap plate 410 is connected to the case 200 to function as a negative electrode, which is the same electrode as the case, the first electrode tab 311 may function as a positive electrode, the lower insulator 440 may prevent a short circuit from being generated by insulating the cap plate 410 and the first electrode tab 311. The lower insulator 440 may be made of a resin such as polypropylene or polyethylene.

The lower insulator 440 may be formed as a disk shape with an insertion hole 441 at the center in the similar manner as the cap plate 410. The protrusion 421 of the terminal plate 420 may penetrate the insertion hole 441 of the lower insulator 440 and the through hole 411 of the cap plate 410 to be placed inside the case 200. The first electrode tab 311 may be coupled to the protrusion 421 of the terminal plate 420. The outer diameter of the lower insulator 440 may be the same as or similar to the outer diameter of the electrode assembly 300. The outer diameter of the lower insulator 440 may be smaller than the outer diameter of the cap plate 410. The insertion hole 441 of the lower insulator 440 may be formed in a size where the cap plate 410 is not exposed to the first electrode tab 311. The diameter of the insertion hole 441 of the lower insulator 440 may be the same as or smaller than the diameter of the through hole 411 of the cap plate 410.

According to some embodiments, the lower insulator 440 may be formed of an insulating tape and coupled to be bottom surface of the cap plate 410, or formed of an insulating sheet and coupled to the bottom surface of the cap plate 410 by a heat melting method.

A secondary battery accommodates an electrode assembly on one open side of a case, and arrange a cap assembly on the one open side of the case to bond the case with the cap assembly by welding. However, when the case is bonded with the cap assembly by welding, an insulating tape attached to a positive electrode tab may melt by welding heat, which may cause the deterioration of insulation.

According to some embodiments of the present disclosure, a sealing tape that surrounds an electrode assembly accommodated in a case of a secondary battery and an insulating tape coupled to a first electrode tab prevents damage to the insulating tape when the case is bonded with the cap assembly by welding.

According to some embodiments of the present disclosure, the outer surface of the sealing tape of the secondary battery is formed of a metal layer to prevent the welding heat generated by welding from being transferred to the electrode assembly and insulating tape.

According to some embodiments of the present disclosure, the metal layer formed on the outer surface of the sealing tape of the secondary battery contacts the inner circumferential surface of the case to transmit the welding heat generated by welding to the case, thereby dissipating the welding heat.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure and the claims and their equivalents, below.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of ordinary skill in the art that various changes in form and details may be made without departing from the spirit and scope of the present invention as set forth in the following claims.

What is claimed is:

1. A secondary battery, comprising:
an electrode assembly including a first electrode having a first electrode tab coupled to an insulating tape, a separator, and a second electrode;
a case accommodating the electrode assembly on one open side, the case being electrically connected to the second electrode;
a cap assembly sealing the one open side of the case, the cap assembly being electrically connected to the first electrode tab;
an insulating sheet between the cap assembly and the electrode assembly; and
a sealing tape surrounding the electrode assembly and the insulating tape.

2. The secondary battery as claimed in claim 1, wherein the sealing tape comprises:
a base part surrounding a periphery of the electrode assembly; and
a bending part bent at an end portion of the base part, the bending part being on the insulating sheet.

3. The secondary battery as claimed in claim 2, wherein the sealing tape comprises:
a metal layer including a metal material;
an insulating layer including an insulating material, the insulating layer being on the metal layer; and
a first adhesive layer on the insulating layer.

4. The secondary battery as claimed in claim 3, wherein the sealing tape further comprises a second adhesive layer between the metal layer and the insulating layer, the second adhesive layer bonding the metal layer with the insulating layer.

5. The secondary battery as claimed in claim 4, wherein each of the base part and the bending part comprises the first metal layer, the second adhesive layer, the insulating layer, and the first adhesive layer.

6. The secondary battery as claimed in claim 5, wherein:
the base part is attached to the periphery of the electrode assembly by the first adhesive layer, and
the bending part is attached to the insulating sheet by the first adhesive layer.

7. The secondary battery as claimed in claim 4, wherein:
the base part comprises the metal layer, the second adhesive layer, the insulating layer, and the first adhesive layer, and
the bending part comprises the metal layer, the second adhesive layer, and the insulating layer.

8. The secondary battery as claimed in claim 7, wherein:
the base part is attached to the periphery of the electrode assembly by the first adhesive layer, and
the bending part is on the insulating sheet, resulting in the insulating layer facing the insulating sheet.

9. The secondary battery as claimed in claim 4, wherein:
the base part comprises the metal layer, the second adhesive layer, the insulating layer, and the first adhesive layer, and
the bending part comprises the metal layer and the second adhesive layer.

10. The secondary battery as claimed in claim 9, wherein:
the base part is attached to the periphery of the electrode assembly by the first adhesive layer, and
the bending part is attached to the insulating sheet by the second adhesive layer.

11. The secondary battery as claimed in claim 3, wherein the metal layer is a coating of a metal material on the insulating layer.

12. The secondary battery as claimed in claim 11, wherein each of the base part and the bending part comprises the metal layer, the insulating layer, and the first adhesive layer.

13. The secondary battery as claimed in claim 12, wherein:
the base part is attached to the periphery of the electrode assembly by the first adhesive layer, and
the bending part is attached to the insulating sheet by the first adhesive layer.

14. The secondary battery as claimed in claim 11, wherein:
the base part comprises the metal layer, the insulating layer, and the first adhesive layer, and
the bending part comprises the metal layer and the insulating layer.

15. The secondary battery as claimed in claim 14, wherein:
the base part is attached to the periphery of the electrode assembly by the first adhesive layer, and
the bending part is on the insulating sheet, resulting in the insulating layer facing the insulating sheet.

16. The secondary battery as claimed in claim 2, wherein the bending part comprises a plurality of notches spaced apart by a predetermined gap along a circumferential direction, the plurality of notches being cut along a direction perpendicular to the circumferential direction.

17. The secondary battery as claimed in claim 2, wherein a length of the bending part is a same as or smaller than a first length from an inner circumferential surface of the case to an end portion of the insulating tape coupled to the first electrode tab, and a same as or greater than a second length from the inner circumferential surface of the case to an end portion of the separator bent in a direction parallel to the bending part.

18. The secondary battery as claimed in claim 2, wherein a length of the bending part is a same as or smaller than a first length from an inner circumferential surface of the case to an end portion of the insulating tape coupled to the first electrode tab, and a same as or greater than a third length from the inner circumferential surface of the case to an end portion of the insulating sheet.

19. The secondary battery as claimed in claim 3, wherein the metal layer includes at least one of copper and a copper alloy.

20. The secondary battery as claimed in claim 3, wherein the insulating layer includes at least one of oriented polystyrene, thermoplastic vulcanizate, polyethylene terephthalate, polypropylene and polyamide.
